(19) United States
(12) Patent Application Publication
(10) Pub. No.: US 2011/0116732 A1
(43) Pub. Date: May 19, 2011

(54) MACHINE HAVING A BACKUP BEARING WITH A LIQUID-METAL ANTI-FRICTION LAYER

(75) Inventor: Hartmut Walter, Tokyo (JP)

(73) Assignee: Siemens Aktiengesellschaft, München (DE)

(21) Appl. No.: 12/920,885

(22) PCT Filed: Mar. 2, 2009
(86) PCT No.: PCT/EP2009/052458

§ 371 Date: Dec. 6, 2010

(30) Foreign Application Priority Data
Mar. 5, 2008 (DE) 10 2008 012 603.9

(51) Int. Cl. F16C 41/04

(52) U.S. Cl. 384/448

(57) ABSTRACT

A machine has a base (2), a rotating element (4) and at least one bearing system (6). Said bearing system (6) has an operating bearing (7) and a backup bearing (8) associated with the operating bearing (7). The backup bearing (8) has a base bearing ring (9) and a rotating element bearing ring (10) that is rotationally arranged relative to the base bearing ring (9). In a normal operating mode of the machine, the rotating element (4) is permanently received by the operating bearing (7) relative to the base (2) in a contact-free manner so that the rotating element bearing ring (10) does not rotate relative to the base bearing ring (9). In a special mode of operation of the machine, in which the rotating element (4) is not received by the operating bearing (7) in a contact-free manner, the rotating element (4) sets the rotating element bearing ring (10) rotating relative to the base bearing ring (9) so that the rotating element (4) is at least temporarily received with contact via the backup bearing (8). A liquid-metal anti-friction layer (11) is arranged between the base bearing ring (9) and the rotating element bearing ring (10).

The present invention relates to a machine,
the machine having a basic body, a rotary element and at least one bearing arrangement,
the bearing arrangement having an operating bearing and a backup bearing assigned to the operating bearing,
the backup bearing having a basic-body bearing ring and a rotary-element bearing ring arranged rotatably in relation to the basic-body bearing ring,
in normal operation of the machine the rotary element being mounted rotatably, permanently free of contact, in relation to the basic body via the operating bearing, so that the rotary-element bearing ring executes no rotational movement in relation to the basic-body bearing ring,
in special operation of the machine, in which the rotary element is not mounted rotatably, free of contact, in relation to the basic body via the operating bearing, the rotary element setting the rotary-element bearing ring in rotation in relation to the basic-body bearing ring, so that the rotary element is mounted rotatably, at least briefly with contact, via the backup bearing.

Machines of this type are generally known, particularly in the form of electric machines. The operating bearings may be designed, for example, as magnetic mountings.

In many applications of rotating machines, backup bearings are required as a fallback level for the operating bearings. The backup bearings must, on the one hand, deal with the shock (impact) if the rotary element falls into the backup bearing and, on the other hand, ensure a reliable rundown of the rotary element. Specific frictional conditions must be present for this purpose. Coefficients of friction which are too high between the rubbing components quickly lead to severe heating within a very short time, thus resulting, in turn, in a short service life of the backup bearing. In most instances, therefore, an unbraked rundown of the rotary element in the backup bearings is not possible. Instead, for reliable operation of plants having contact-free operating bearings, braking devices have to be provided which, where appropriate, brake the rotary element very quickly.

Various embodiments are known for backup bearings. Thus, for example, it is known to design backup bearings as rolling bearings. In this case, one of the bearing rings of the rolling bearing, usually the outer ring, is connected to a bearing plate. The inside diameter of the inner ring of the bearing is in this case somewhat larger than the outside diameter of the rotary element, insofar as the latter is led through the inner ring. In the event of a failure of the operating bearing, the rotary element falls into the inner ring. After a very short time, the inner ring and the rolling bodies of the rolling bearing are accelerated. The rotary element can run down. However, a backup bearing designed as a rolling bearing is unsuitable for high weights of the rotary element. Where high weights are concerned, therefore, dry-running plain bearings are used. In dry-running plain bearings, one or more bronze layers are located on the bearing inner ring and/or the bearing outer ring. However, the bronze layers become worn very quickly, and therefore an exchange of the backup bearings is necessary after only a few rundown actions.

The object of the present invention is to configure a machine of the type described initially, in particular its backup bearings, in such a way that the backup bearings have a long service life. In particular, the frictional heat arising during the rundown of the rotary element is to be avoided as far as possible or is to be rendered harmless in another way.

The object is achieved by means of a machine having the features of claim 1. Possible refinements are the subject matter of dependent claims 2 to 9.

According to claim 1, there is provision for configuring a machine of the type initially mentioned in such a way that an anti-friction layer formed as liquid metal is arranged between the basic-body bearing ring and the rotary-element bearing ring. By virtue of this refinement, on the one hand, the frictional resistance can be markedly reduced. On the other hand, good thermal coupling of the rotary-element bearing ring to the basic-body bearing ring, and vice versa, is obtained, so that frictional heat which nevertheless arises can be dissipated quickly.

As a rule, the basic-body bearing ring is designed as a bearing outer ring and the rotary-element bearing ring as a bearing inner ring. In individual instances, however, a reversed arrangement is also possible.

Furthermore, as a rule, the basic-body bearing ring is arranged fixedly in terms of rotation in relation to the basic body, and in normal operation the rotary-element bearing ring is spaced apart from the rotary element. In individual instances, however, conversely, the rotary-element bearing ring may be arranged fixedly in terms of rotation in relation to the rotary element, and in normal operation the basic-body bearing ring may be spaced apart from the basic body.

In a preferred refinement of the present invention, a spring device is arranged between the bearing ring arranged fixedly in terms of rotation (usually the basic-body bearing ring designed as a bearing outer ring) and the element, in relation to which the respective bearing ring is arranged fixedly in terms of rotation (usually the basic body), by means of which spring device an impact occurring during the transition from normal operation to special operation can be cushioned. In the customary construction, the impact is in this case triggered by a fall of the rotary element into the rotary-element bearing ring designed as a bearing inner ring.

Alternatively or additionally to the presence of the spring device, it is possible that the bearing ring not arranged fixedly in terms of rotation (usually the rotary-element bearing ring designed as a bearing inner ring) has a spring-elastic intermediate layer, by means of which the impact occurring during the transition from normal operation to special operation can be cushioned.

Preferably, the backup bearing has a gap seal, by means of which the liquid metal is retained. This relatively simple refinement affords an especially long service life of the backup bearing.

As a rule, just by the anti-friction layer being formed as liquid metal, the friction is greatly reduced, so that only an insignificant heating of the backup bearing occurs in special operation. In individual instances, however, it may nevertheless be expedient for at least one block composed of a metal which melts at a low temperature to be arranged in the basic body and/or in the basic-body bearing ring and/or in the rotary element and/or in the rotary-element bearing ring. The block is in this case coupled thermally to the liquid metal in such a way that it melts during special operation.

Further advantages and details may be gathered from the following description of an exemplary embodiment, in conjunction with the drawings in which, in a basic illustration,

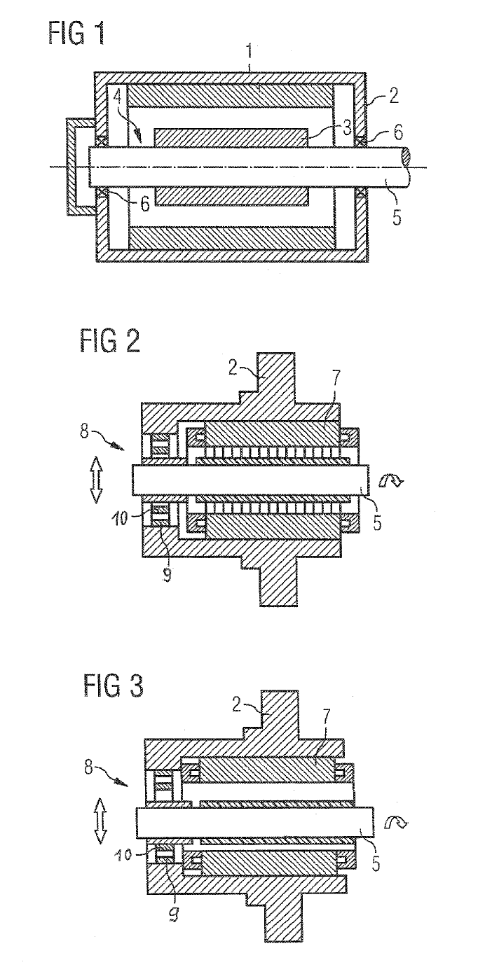

FIG. 1 shows diagrammatically a machine,

FIG. 2 shows diagrammatically a bearing arrangement in normal operation,

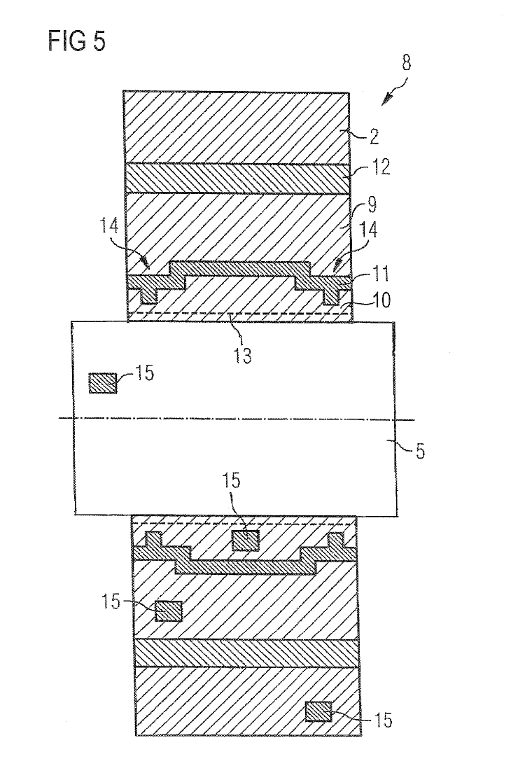

FIG. 3 shows the bearing arrangement of FIG. 2 in special operation, and

FIG. 4 shows a backup bearing.

According to FIG. 1, a machine is designed as an electric machine. It has a stator 1 which is arranged in a basic body 2 of the machine. Furthermore, it has a rotor 3 which is an integral part of a rotary element 4 of the machine. The rotary element 4, furthermore, has a rotor shaft 5 which is mounted in bearing arrangements 6. According to FIG. 1, in this case, a plurality of bearing arrangements 6 are present. Two bearing arrangements 6 are depicted in FIG. 1. The bearing arrangements 6, as a rule, are of identical design. If more than two bearing arrangements 6 are present, however, this is not absolutely necessary.

The above-described embodiment of the machine as an electric machine is purely by way of example. Alternatively, the machine could be designed, for example, as a compressor or as a gear.

The set-up of one of the bearing arrangements 6 is explained in more detail below in connection with FIGS. 2 and 3.

According to FIGS. 2 and 3, the bearing arrangement 6 illustrated has an operating bearing 7 and a backup bearing 8. The backup bearing 8 is in this case assigned to the operating bearing 7. The backup bearing 8 has a basic-body bearing ring 9 and a rotary-element bearing ring 10. The rotary-element bearing ring 10 is arranged rotatably in relation to the basic-body bearing ring 9.

When the machine is in normal operation—see FIG. 2—, the rotary element 4 (more specifically: the rotor shaft 5) is mounted rotatably, permanently free of contact, in relation to the basic body 2 via the operating bearing 7. The rotary-element bearing ring 10 therefore executes no rotational movement in relation to the basic-body bearing ring 9. By contrast, when the machine is in special operation—see FIG. 3—, the rotary element 4 (more specifically: the rotor shaft 5) is not mounted rotatably, free of contact, in relation to the basic body 2 via the operating bearing 7. Instead, the rotary element 4 sets the rotary-element bearing ring 10 in rotation in relation to the basic-body bearing ring 9. For this purpose, inter alia, it is necessary to have a suitable coordination of the coefficients of friction which occur at the contact faces of the rotor shaft 5 with the rotary-element bearing ring 10, and the rotary-element bearing ring 10 with the basic-element bearing ring 9, etc. This coordination is known to specialists and as such is not the subject of the present invention.

In special operation, the rotary element 4 is mounted rotatably, with contact, via the backup bearing 8. In individual instances, it may be possible that special operation can be maintained for a lengthy period of time. As a rule, however, it is sufficient if special operation is possible only briefly. This is because special operation is usually required only when either the operating bearing 7 (for example, because of the failure of a power supply of electromagnets of the operating bearing 7) fails and/or the rotary element 4 is running up or running down.

FIGS. 2 and 3 illustrate customary construction of the backup bearing 8. In the customary construction, the basic-body bearing ring 9 is designed as a bearing outer ring. The rotary-element bearing ring 10 is designed correspondingly thereto as a bearing inner ring. Furthermore, in the customary construction of the backup bearing 8, the basic-body bearing ring 9 is arranged fixedly in terms of rotation in relation to the basic body 2. In this construction, in normal operation (see FIG. 2) the rotary-element bearing ring 10 is spaced apart from the rotary element 4 (or the rotor shaft 5). In individual instances, however, it may be expedient to design the basic-body bearing ring 9 as a bearing inner ring and, correspondingly thereto, to design the rotary-element bearing ring 10 as a bearing outer ring. Alternatively or additionally, it may be expedient, in individual instances, to arrange the rotary-element bearing ring 10 fixedly in terms of rotation in relation to the rotary element 4 (in particular, to fasten it on the rotor shaft 5), so that the basic-body bearing ring 9 is spaced apart from the basic body 2 in normal operation.

FIG. 4, then, on the basis of the above-described typical embodiment of the backup bearing 8, shows the embodiment according to the invention of the backup bearing 8. According to FIG. 4, an anti-friction layer 11 is arranged between the basic-body bearing ring 9 and the rotary-element bearing ring 10. The anti-friction layer 11 is in this case formed as liquid metal, for example is obtainable under the trade name Galinstan from the company Geratherm Medical AG, 98716 Geschenda (FRG). This is a gallium/indium/tin compound.

The above-described construction of the backup bearing, that is to say the presence of the anti-friction layer 11 formed as liquid metal, may even in many instances be sufficient to bring about a long service life of the backup bearing 8. The possible embodiments of the backup bearing 8 which are explained in more detail below in connection with FIG. 4 are therefore advantageous, but not absolutely necessary.

According to FIG. 4, a spring device 12 is arranged between the bearing ring arranged fixedly in terms of rotation (here: the basic-body bearing ring 9 designed as a bearing outer ring) and the element, in relation to which the respective bearing ring is arranged fixedly in terms of rotation (here: the basic body 2). The spring device 12 may be designed, for example, as an elastomeric layer. Alternatively, the spring device 12 may comprise, for example, springs. By means of the spring device 12, an impact which occurs during the transition from normal operation to special operation (typically, when the rotary element 4 falls into the backup bearing 8) can be cushioned.

Alternatively or additionally to the presence of the spring device 12, the bearing ring not arranged fixedly in terms of rotation (usually the rotary-element bearing ring 10 designed as a bearing inner ring) may have a spring-elastic intermediate layer 13. The spring-elastic intermediate layer 13 may be designed, for example, as elastomer. It serves the same function as the spring device 12.

According to FIG. 4, furthermore, the backup bearing 8 has a gap seal 14. The liquid metal 11 is retained by means of the gap seal 14, so that it cannot emerge from the interspace between the basic-body bearing ring 9 and the rotary-element bearing ring 10. The set-up and mode of operation of a gap seal 14 are generally known to specialists, and therefore there is no need for any more detailed information regarding this.

On account of the presence of the anti-friction layer 11 formed as liquid metal, frictional forces are markedly reduced.

There is therefore usually no risk of overheating of the backup bearing 8 during special operation. In individual instances, however, it may nevertheless be expedient, according to FIG. 4, to provide one or more blocks 15 composed of a metal which melts at a low temperature and to couple the block 15 or blocks 15 thermally to the liquid metal 11 in such a way that the block 15 melts in special operation or the blocks 15 melt in special operation. Metals of this type are known and as such are not the subject of the present invention.

The arrangement of the block 15 or blocks 15 may be carried out as required. In particular, an arrangement in the basic body 2, in the basic-body bearing ring 9, in the rotary element 4 (or the rotor shaft 5) and in the rotary-element bearing ring 10 is possible. Any desired combinations of these are also possible.

The present invention has many advantages. In particular, due to the use of the anti-friction layer 11 formed as liquid metal, a wear-free, robust and maintenance-friendly backup bearing 8 is provided, which is suitable for virtually all weight classes of the rotary element 4. Furthermore, due to the use of the spring device 12 and/or of the spring-elastic intermediate layer 13, shock-like load during the transition from normal operation to special operation is avoided, with the result that the load upon the backup bearing 8 is reduced even further. On account of the extremely low coefficient of friction, scarcely any frictional heat arises even during operation at high rotational speeds and with high weights of the rotary element 4. The service life of the backup bearing 8 is increased significantly.

The above description serves solely for explaining the present invention. By contrast, the scope of protection of the present invention is to be determined solely by the accompanying claims.

1-9. (canceled)

10. A machine, comprising:
a basic body;
a rotary element;
at least one bearing arrangement having an operating bearing for rotatably supporting the rotary element in relation to the basic body during normal operation, and a backup bearing for rotatably supporting the rotary element in relation to the basic body at a time of irregular operation, said backup bearing having a basic-body bearing ring and a rotary-element bearing ring in spaced apart relationship, wherein during normal operation the rotary element is not contacted by the backup bearing in the absence of a relative rotation between the rotary-element bearing ring and the basic-body bearing ring, while during irregular operation the rotary element causes the rotary-element bearing ring to rotate in relation to the basic-body bearing ring as a result of a contact between the rotary element and the backup bearing; and
an anti-friction layer in the form of a liquid metal arranged between the basic-body bearing ring and the rotary-element bearing ring.

11. The machine of claim 1, wherein the basic-body bearing ring is designed as a bearing outer ring, and the rotary-element bearing ring is designed as a bearing inner ring.

12. The machine of claim 1, wherein the basic-body bearing ring is designed as a bearing inner ring, and the rotary-element bearing ring is designed as a bearing outer ring.

13. The machine of claim 1, wherein the basic-body bearing ring is arranged fixedly non-rotatably to the basic body, and in normal operation the rotary-element bearing ring is spaced apart from the rotary element.

14. The machine of claim 1, wherein the rotary-element bearing ring is secured in fixed rotative engagement with the rotary element, and in normal operation the basic-body bearing ring is spaced apart from the basic body.

15. The machine of claim 1, further comprising a spring device arranged between the basic-body bearing ring and the basic body to cushion an impact encountered during a transition from normal operation to irregular operation.

16. The machine of claim 1, wherein the rotary-element bearing ring has a spring-elastic intermediate layer to cushion an impact encountered during a transition from normal operation to irregular operation.

17. The machine of claim 1, wherein the backup bearing has a gap seal to retain the liquid metal.

18. The machine of claim 1, further comprising at least one block made of a metal which melts at a low temperature and arranged in at least one member selected from the group consisting of the basic body, the basic-body bearing ring, the rotary element, and the rotary-element bearing ring, said block being coupled thermally to the liquid metal so as to melt during irregular operation.

19. A backup bearing for rotatably supporting a rotary element at a time of irregular operation of a machine, said backup bearing comprising:
a first bearing ring;
a second bearing ring capable of rotating relative to the first bearing ring during irregular operation as a result of a contact between the rotary element and the second bearing ring; and
an anti-friction layer in the form of a liquid metal arranged in a space between the first and second bearing rings.

20. The backup bearing of claim 19, wherein first bearing ring is designed as a bearing outer ring, and the second bearing ring is designed as a bearing inner ring.

21. The backup bearing of claim 19, wherein the first bearing ring is designed as a bearing inner ring, and the second bearing ring is designed as a bearing outer ring.

22. The backup bearing of claim 19, further comprising a spring device arranged adjacent a rotary-element distal surface of the first bearing ring.

23. The backup bearing of claim 19, wherein the second bearing ring has a spring-elastic intermediate layer formed within the second bearing ring.

24. The backup bearing of claim 19, further comprising a gap seal to seal off the space to thereby retain the liquid metal.

25. The backup bearing of claim 19, further comprising at least one block made of a metal which melts at a low temperature and arranged in at least one of the first and second bearing rings, said block being coupled thermally to the liquid metal so as to melt during irregular operation.
